(19) United States
(12) Patent Application Publication
(10) Pub. No.: US 2015/0310408 A1
(43) Pub. Date: Oct. 29, 2015

(54) System and Method for Bill Splitting

(71) Applicant: Reserve Media, Inc., New York, NY (US)

(72) Inventor: Daniel James Anderson, New York, NY (US)

(73) Assignee: Reserve Media, Inc., New York, NY (US)

(21) Appl. No.: 14/698,485

(22) Filed: Apr. 28, 2015

Related U.S. Application Data
(60) Provisional application No. 61/985,037, filed on Apr. 28, 2014.

(51) Int. Cl. G06Q 20/14; G06Q 30/04

(52) U.S. Cl. CPC G06Q 20/14; G06Q 30/04

(57) ABSTRACT

A billing system for making reservations at an establishment and splitting the resultant bill and methods for manufacturing and using same. The billing system includes a plurality of user devices, an application server, and at least one establishment device. One embodiment includes selecting a invitee user profile for addition to a split set associated with the reservation, the split set initially comprising an organizing user profile; sending a split invitation to a invitee user device associated with the invitee user profile; receiving a split-accept notification from the invitee user device; adding the user profile to the split set; and paying the bill by paying a first portion of the bill via a first payment method associated with the invitee user profile and paying a second portion of the bill via a second payment method associated with the organizing user profile.

### CROSS-REFERENCE TO RELATED APPLICATIONS

This application is a non-provisional of, and claims the benefit of, U.S. Provisional Application Serial No. 61/985,037, entitled “SYSTEMS, METHODS, AND COMPUTER PROGRAM PRODUCTS FOR PAYING AND SPLITTING BILL AT RESTAURANT OR BAR,” filed Apr. 28, 2014. The provisional application is hereby incorporated herein by reference in its entirety and for all purposes.

### BACKGROUND

Conventionally, when patrons of a restaurant or other establishment are ready to pay their bill and leave, the patrons must wait until their server approaches their table or until they catch the attention of the server to request a copy of their bill. Once a final bill has been requested, the server goes to the restaurant's point-of-sale (POS) system, tallies the total, applies sales tax, prints the bill and returns to the patrons' table. After again waiting for the server's return, the patrons pay the server with cash or a credit card and then must further wait for the server to yet again return with change or to complete a credit card transaction.

One drawback of this conventional method is that the method is slow and prone to errors and fraud. Patrons frequently are frustrated by the method, and, if the server is busy, the inherently-slow method can take even longer. This method also prevents the server from being able to attend to other customers and slows down the table turnover time, leading to longer waits for other patrons and fewer total patrons for the restaurant or bar.

Another drawback of conventional methods of paying bills is that the restaurant is susceptible to theft in the situation where a patron leaves without paying, especially in the case of a busy establishment where patrons can come and go without being easily noticed.

Yet another drawback is that individual patrons within a group of patrons are unable to easily pay separately for respective portions of the bill when the group dines together. This can be frustrating to patrons, and many restaurants are unwilling to split large orders because of the inefficiencies in the payment process mentioned above.

Some mobile computing device technologies allow users to input and store their credit card information on their mobile computing devices (or allow the software application to access credit card data from the Internet or cloud when requested), and then use the software application to pay for an item with the “digital” version of the credit card. This approach removes the need for carrying such physical cards, but it does not allow for establishments to be automatically paid for any bill incurred, nor does it allow for bill splitting without the involvement of the establishment.

In view of the foregoing, a need exists for an improved billing system and method for splitting and paying bills in an effort to overcome the aforementioned obstacles and deficiencies of conventional billing systems.

### BRIEF DESCRIPTION OF THE DRAWINGS

FIG. 1 is an exemplary top-level drawing illustrating an embodiment of a billing system, which includes user devices and an application server.

FIG. 2 is an exemplary data flow diagram illustrating an embodiment of communications between the user devices and application server of FIG. 1 for generating a reservation and adding a participant to the reservation.

FIG. 3 is an exemplary flow chart illustrating an embodiment of a method of generating a reservation and adding a participant to the reservation in accordance with the data flow diagram of FIG. 2.

FIG. 4 is an exemplary data flow diagram illustrating an embodiment of communications between user devices and an application server for a participant joining a reservation.

FIG. 5 is an exemplary flow chart illustrating an embodiment of a method of a participant joining a reservation in accordance with the data flow diagram of FIG. 4.

FIG. 6 is an exemplary data flow diagram illustrating an embodiment of communications between user devices and an application server for a splitting a bill.

FIG. 7 is an exemplary flow chart illustrating an embodiment of a method for splitting a bill in accordance with the data flow diagram of FIG. 6.

FIG. 8a is a screen shot of a user interface in an embodiment of generating a reservation and adding participants to the reservation.

FIG. 8b is a screen shot of a user interface in an embodiment of generating a reservation and adding participants to the reservation.

FIG. 8c is a screen shot of a user interface in an embodiment of generating a reservation and adding participants to the reservation.

FIG. 8d is a screen shot of a user interface in an embodiment of generating a reservation and adding participants to the reservation.

FIG. 8e is a screen shot of a user interface in an embodiment of generating a reservation and adding participants to the reservation.

FIG. 8f is a screen shot of a user interface in an embodiment of generating a reservation and adding participants to the reservation.

FIG. 9a is a screen shot of a user interface in an embodiment of a user joining a reservation.

FIG. 9b is a screen shot of a user interface in an embodiment of a user joining a reservation.

FIG. 9c is a screen shot of a user interface in an embodiment of a user joining a reservation.

FIG. 9d is a screen shot of a user interface in an embodiment of a user joining a reservation.

FIG. 9e is a screen shot of a user interface in an embodiment of a user receiving a split payment confirmation.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

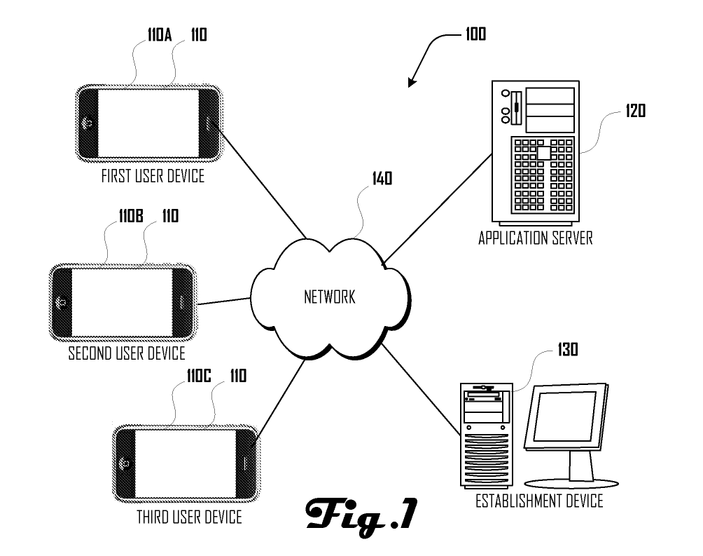

Since currently-available billing systems are deficient, a billing system that is configured for bill splitting can prove desirable and provide a basis for a wide range of applications, such as making a reservation, adding one or more participant to the reservation, splitting a bill associated with the reservation and paying a bill associated with the reservation. This result can be achieved, according to one embodiment disclosed herein, by a billing system 100 as illustrated in FIG. 1.

Turning to FIG. 1, the billing system 100 is shown as comprising a first, second and third user device 110A, 110B, 110C, an application server 120 and an establishment device 130, which are operably connected via a network 140. Although this example system 100 is shown comprising three user devices 110, in further embodiments, there can be any suitable plurality of user devices 110, a single user device 110 or a user device 110 can be absent. Similarly, in some embodiments, there can be any suitable plurality of any of the application server 120 and/or establishment device 130. For example, in various embodiments, there can be one or more establishment device 130 associated with a plurality of establishments (e.g., restaurants, bars, stadiums, concert halls, casinos, dance clubs, and the like).

In accordance with various embodiments, a plurality of users can be associated with one or more user device 110 and can communicate with the application server 120 and/or establishment device 130 to make reservations, invite users to a reservation, split a bill among participants of a reservation, pay a bill, and the like, as discussed in more detail herein.

Although the user devices 110 are shown as being smartphones, in various embodiments, user devices 110 can be any suitable type of device, including a laptop computer, a desktop computer, a gaming device, a tablet computer, a wearable computing device, a headset computing device, and the like. Similarly, the application server 120 and establishment device 130 can also be any suitable type of device. Accordingly, the example devices shown and described herein should not be construed to be limiting on the wide variety of devices and number of devices that are within the scope and spirit of the present disclosure.

Additionally, the network 140 can comprise any suitable wired and/or wireless network, including the Internet, a cellular network, a WiFi network, a local area network (LAN) a wide area network (WAN) or the like.

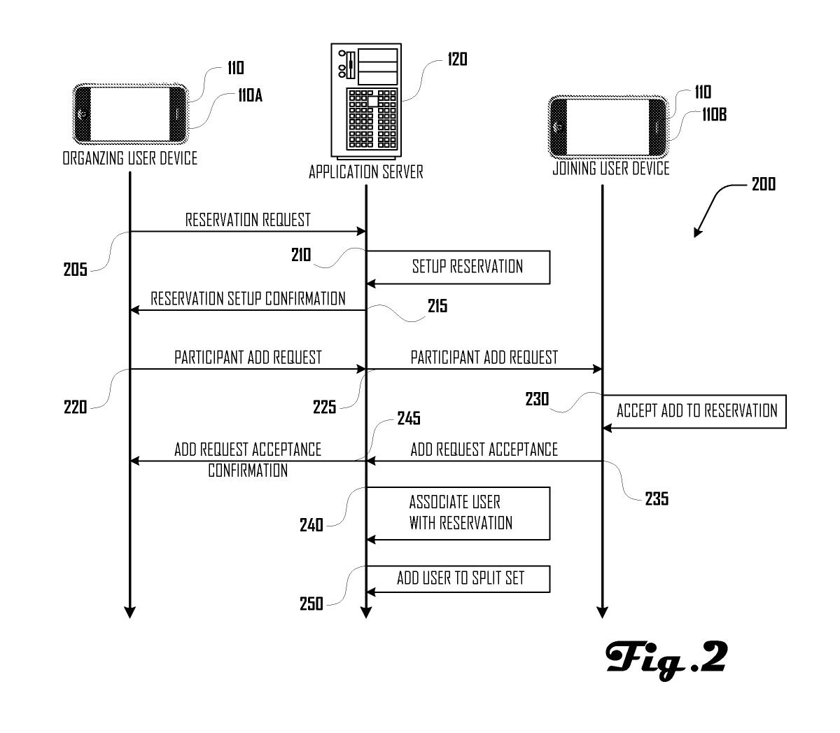

FIG. 2 is an exemplary data flow diagram illustrating an embodiment of communications 200 between user devices 110 and an application server 120 for generating a reservation and adding a participant to the reservation. As illustrated in FIG. 2, the communications 200 begin, at 205, where a reservation request is sent from an organizing user device 110A to the application server 120, and, at 210, a reservation is setup at the application server 120. At 215, a reservation setup confirmation is sent to the user device 110A. For example, FIG. 8a illustrates a screen shot of an interface displaying an exemplary embodiment of a reservation confirmation 805.

In one example embodiment, a user can desire to setup a reservation at a restaurant or other establishment, and the user device 110 can be configured to setup such a reservation. In various embodiments, the user can search for establishments that are associated with the billing system 100 (shown in FIG. 1) and can determine dates and/or times when a reservation would be available at one or more various establishments. In some embodiments, such reservations schedules can be stored and/or accessed via the application server 120, but, in some embodiments, such reservations schedules can be stored or accessed via an establishment device 130 (shown in FIG. 1). In an example where a user desires a reservation at a restaurant, the user can search for restaurants filtered by one or more of cost, location, type of food, number of attendees in reservation, available reservation times, and the like. As discussed herein, a user that is being invited or will be invited to join a reservation and/or a split set can be a joining, invited or invitee user.

Returning to FIG. 2, the communications 200 continue, at 220, where a participant add request is sent to the application server 120, and, at 225, a participation add request is sent to a joining user device 110B. For example, referring to FIGS. 8a-e, in one embodiment, a user can click a “Split the Check” button 810 of an interface 800 (shown in FIG. 8a), and the user can receive a prompt 815 (shown in FIG. 8b) that requests permission for the application server 120 to access user contacts stored on the user device 110. In some embodiments, providing access to user contacts can be required for adding participants. However, in other embodiments, an organizing user can invite users to the reservation, even if the organizing user does not provide access to user contacts. For example, by inputting contact information (e.g., a phone number, e-mail address, or the like), or selecting from a list of recently invited users, the organizing user can invite users with or without providing access to user contacts stored on the user device 110A.

As illustrated in FIG. 8c, the user can select one or more contacts to invite to the reservation and/or a split set. Additionally, in some embodiments, the interface 800 can display whether the contact is a registered member of the billing system 100. In some embodiments, the application server 120 can identify contacts that are registered members by comparing contact data with contact data of registered users. Such a comparison can include a comparison of e-mail address, phone number, mailing address, Facebook identifier, Twitter identifier, or the like.

Although FIG. 2 illustrates a participant add request being sent to the invitee or joining user device 110B via the application server 120, in some embodiments, the user device 100A can send a participant add request to the joining user device 110B directly without the application server 120. Such a participant add request can be send in various suitable ways, including via e-mail, text message, Facebook message, Tweet, or the like. As illustrated in FIGS. 8d-e the interface 800 can confirm that participant requests have been sent to the selected contacts. For example, in the embodiment shown in FIG. 8d, an indication is provided that invitations were sent to users “Stacey Boards,” “Eric Ellis,” and “Greg Lands” and that acceptance by these users is pending.

In various embodiments, the organizing user can send a reminder to an invited/invitee user. For example, in some embodiments, the organizing user can be automatically prompted after a predetermined period of time and/or at a predetermined period of time before a reservation, or the like, regarding whether the organizing user desires to send a reminder to invited/invitee users who have not yet responded to an invitation (e.g., accepted or declined the invitation). In some embodiments, such reminders can be automatically sent, and/or the organizing user can selectively send reminders to invited/invitee users as desired. In some embodiments, reminders can be sent via the same manner that the invitation was sent and/or via a new (or alternative) communication method.

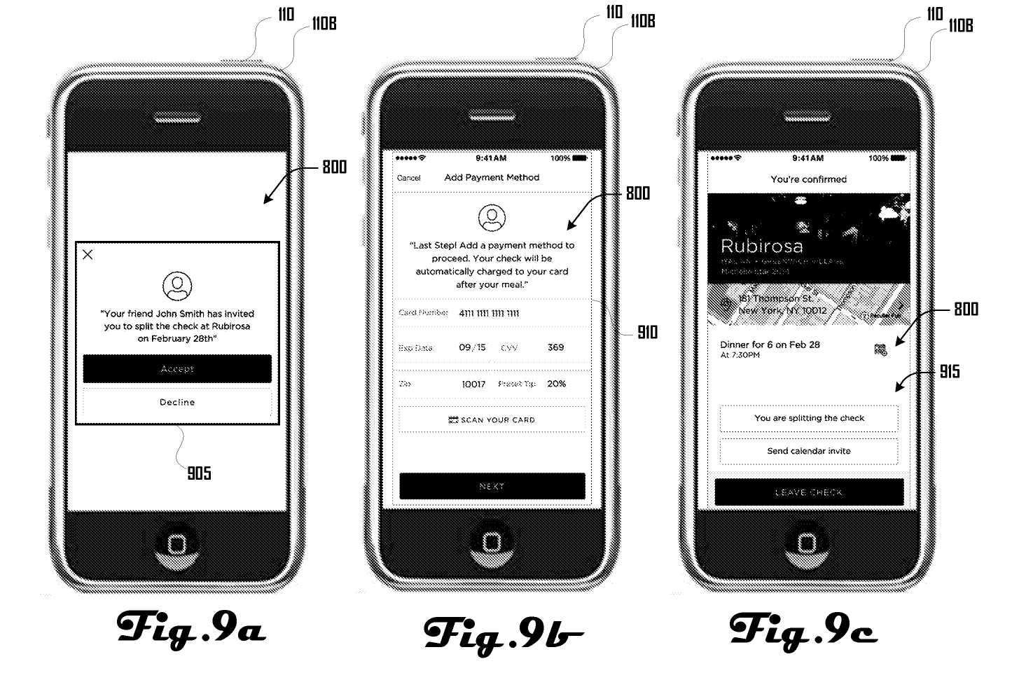

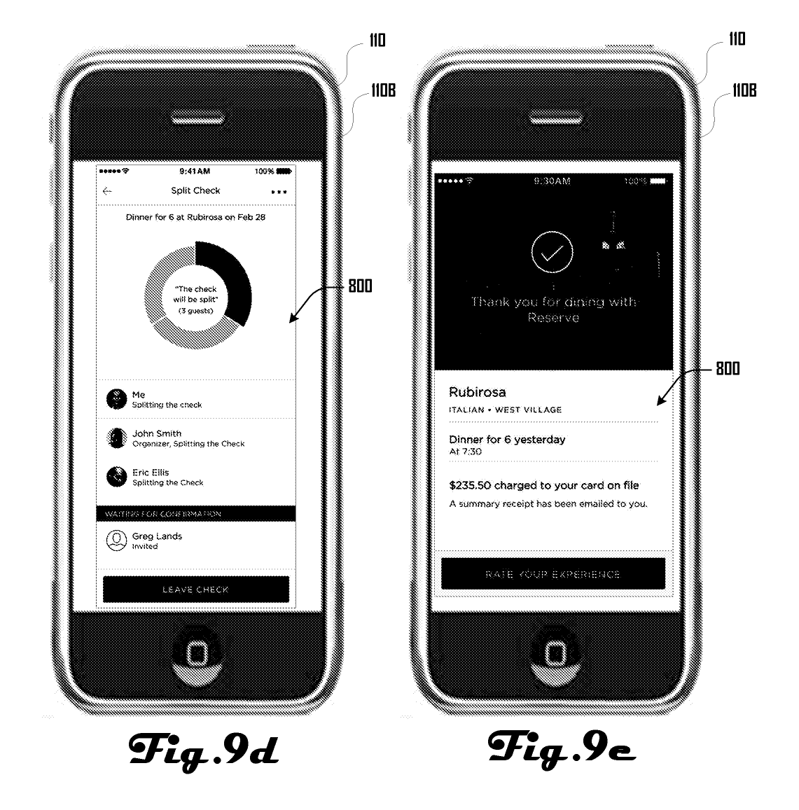

Returning to the communications 200 of FIG. 2, at 230, the addition to the reservation is accepted at the invitee/joining user device 110B, and an add request acceptance is sent to the application server 120, at 235. The application server 120 associates the accepting user with the reservation, at 240, and an add request acceptance confirmation is sent to the organizing user device 110A, at 245. For example, as illustrated in FIG. 9a, a joining user device 110B can present an add request 905, which can include an invitation to split a check associated with a reservation.

In some embodiments, the joining user can be required to provide payment information to join the reservation and/or split set. For example, FIG. 9b illustrates the interface 800 presenting a credit or debit card input 910 on the joining user device 110B. Once the user has accepted the add request and met any other requirements (e.g., providing a payment method, contact information, account setup information, user identification, a password, or the like), then the joining user device 110B can present a confirmation 915 as illustrated in FIG. 9c. Additionally, as shown in FIG. 9d the joining user device 110B can present other users that are associated with a reservation and/or a split set. In various embodiments, accepted reservations can be added to a calendar program on a user device 110 selectively and/or automatically.

As shown in to FIGS. 8e and 8f, at the organizing user device 110A, the interface 800 can present a confirmation that one or more joining user has accepted an add request. Specifically, as shown in FIG. 8e, an indication is provided that user “Stacey Boards” has accepted an add request, whereas users “Eric Ellis,” and “Greg Lands” have not. In FIG. 8f, an indication is provided that users “Stacey Boards” and “Eric Ellis” have accepted an add request, whereas user “Greg Lands” has not.

In some embodiments, a user accepting a reservation can be required to become a registered user with the billing system 100, but, in some embodiments, registration is not required. Registration can include a user confirming and/or inputting contact information, user information, billing information and the like. For example, in one embodiment, a user can be required to provide valid billing information before being registered.

Returning to the communications 200 of FIG. 2, at 250, the accepting user is added to a split set. For example, referring to FIGS. 8d-f, the interface 800 can present a confirmation that one or more joining user has been added to the split set via a split indicator 820. In some embodiments, as illustrated in FIG. 2, a joining user is automatically added to a split set upon joining a reservation and, when paying a bill is initiated by the organizing user and/or a joined or participating user, the bill can automatically be split among the users in the split set. Additionally and/or alternatively, in some embodiments, a user can be invited to join a split set once the user has joined a reservation as discussed in more detail herein.

In various embodiments, joined or participating users can be removed from or disassociated with a reservation and/or a split set. For example, the organizing user can selectively delete a joined or participating user. Alternatively, joined or participating users can delete themselves. Similarly, joining, invitee or invited users can be un-invited. For example, the organizing user can selectively delete an invited user. Alternatively, the joining, invitee or invited users can decline an invitation and/or cancel an invitation.

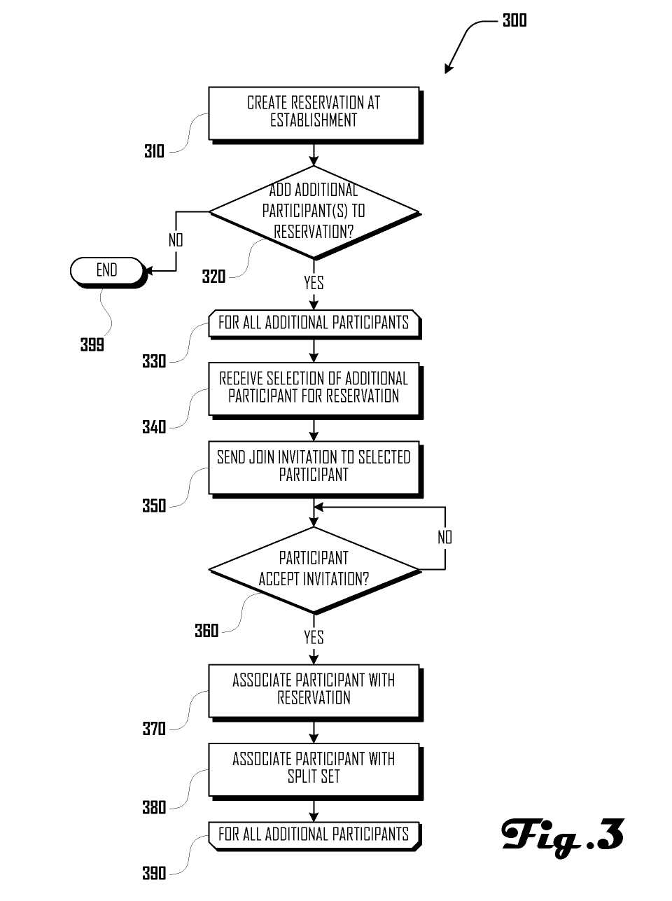

FIG. 3 is an exemplary flow chart illustrating an embodiment of a method 300 of generating a reservation and adding a participant to the reservation (i.e. a user or joining user becomes a participant user associated with the reservation). The method 300 begins, at 310, where a reservation at an establishment is created, and, at 320, a determination is made whether additional participants are being added to the reservation. If not, the method 300 ends, at 399.

If so, the method 300 continues to looping block 330, which begins a loop for all selected additional participants or candidate participants. At 340, a selection of an additional candidate participant for the reservation is received, and, at 350, a join invitation is sent to the selected candidate participant 350. At 360, a determination is made whether the candidate participant has accepted the invitation. If not, the method 300 loops and waits until the invitation is accepted; however, if the invitation is accepted, at 370, the candidate participant is associated with the reservation and becomes a participant. At 380, the participant is associated with a split set associated with the reservation and the loop ends, at 390, for all additional participants.

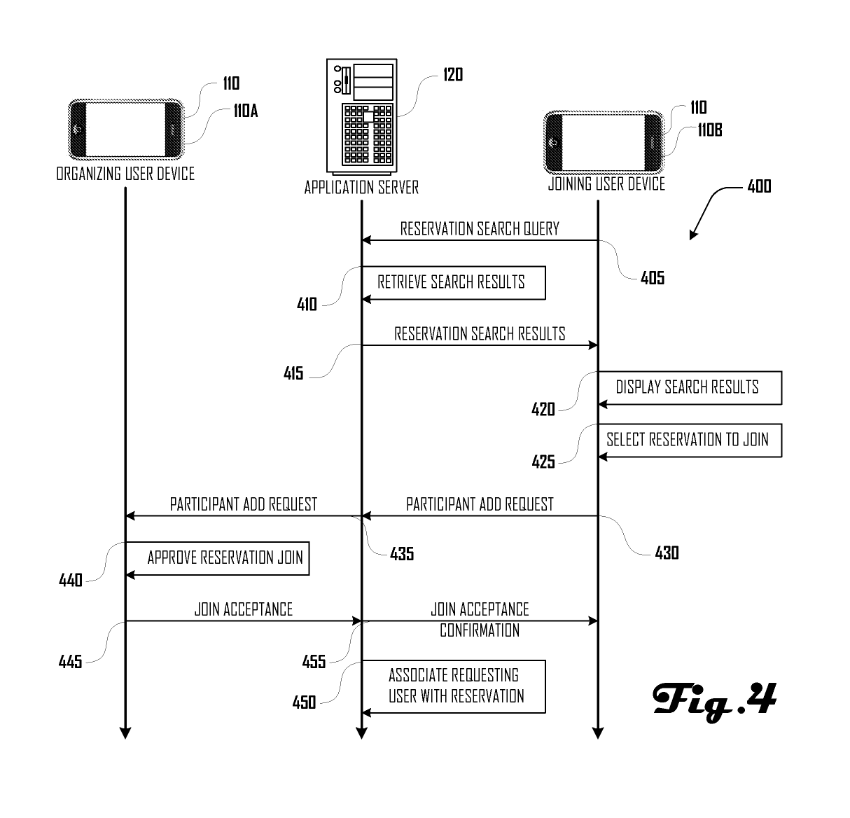

In various embodiments, a joining user or candidate participant can search for a reservation instead of receiving an invitation to join a reservation. For example, FIG. 4 is an exemplary data flow diagram illustrating an embodiment of communication 400 between user devices 110 and an application server 120 for a participant joining a reservation. The communication begins, at 405, where a reservation search query is sent to the application server 120 from a joining user device 110B. For example, such a query can comprise a search based on a user name, e-mail address, establishment, date and/or time, phone number, Facebook identifier, or the like.

At 410, search results are retrieved and, at 415, sent to the user device 110B. The user device 110B displays the search results, at 420, and a reservation to join is selected, at 425. A participant add request is sent to the application server 120, at 430, and a participant add request is sent to the organizing user device 110A, at 435, where the reservation join request is approved, at 440. A join acceptance is sent to the application server 120, at 445, and the application server 120 associates the requesting user with the reservation, at 450. A join acceptance confirmation is sent to the joining user device 110B, at 455.

As discussed herein, in some embodiments, association with a reservation automatically creates association with a split set. Additionally and/or alternatively, in some embodiments, the participating user can receive an invitation to join a split set. Additionally and/or alternatively, in further embodiments, a user need not be associated with a reservation to receive an invitation to join a split set and/or pay a portion of a bill.

FIG. 5 is an exemplary flow chart illustrating an embodiment of a method 500 of a participant joining a reservation. The method 500 begins, at 510, where a reservation search query is received, and, at 520, reservation search results are sent. At 530, a determination is made whether a reservation selection is received, and if not, the method 500 waits until a selection is received. At 540, a participant join request is sent to the reservation creator. At 550, a determination is made whether a participant join approval is received and the method 500 waits until a participant join approval is received, and, at 560, the requesting participant is associated with the reservation.

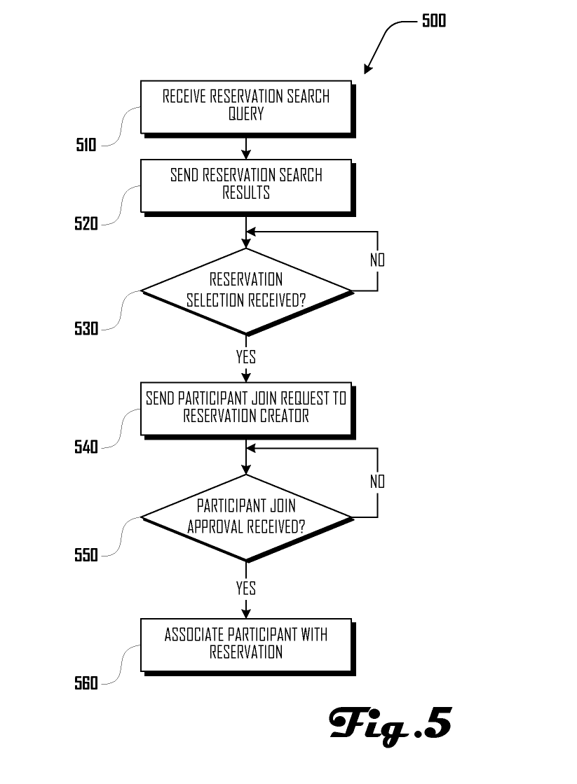

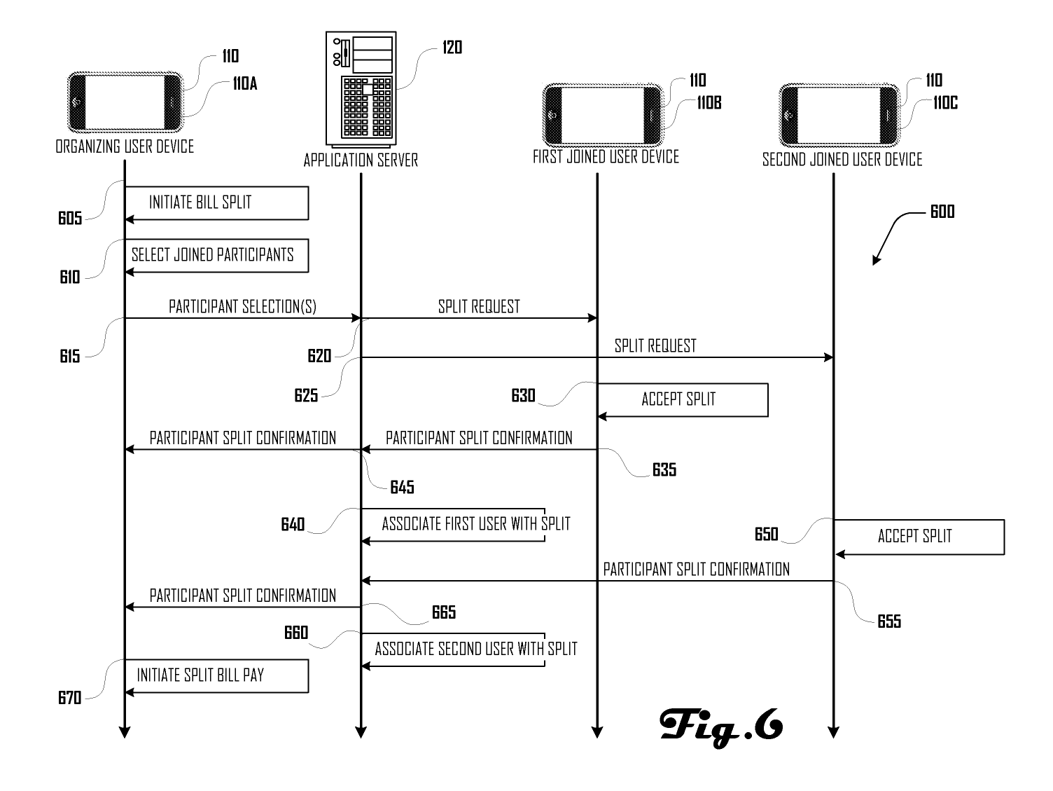

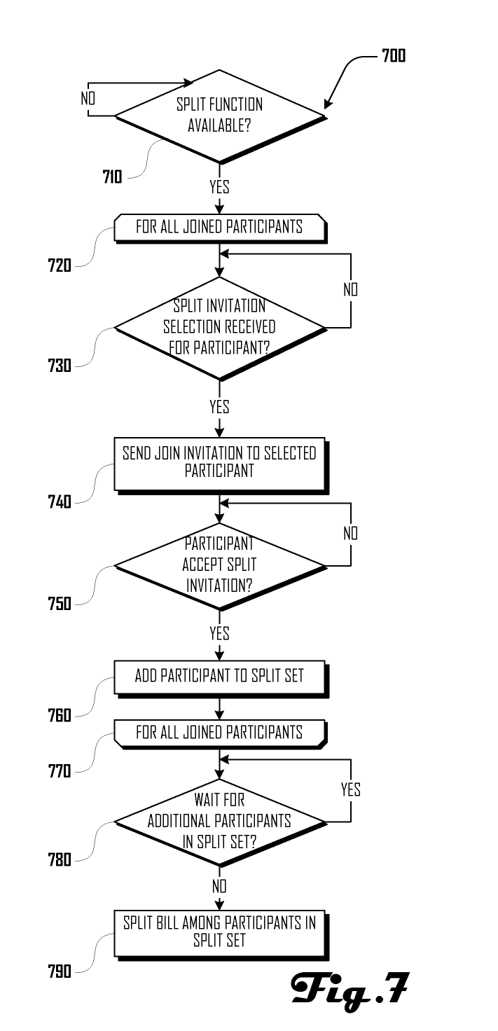

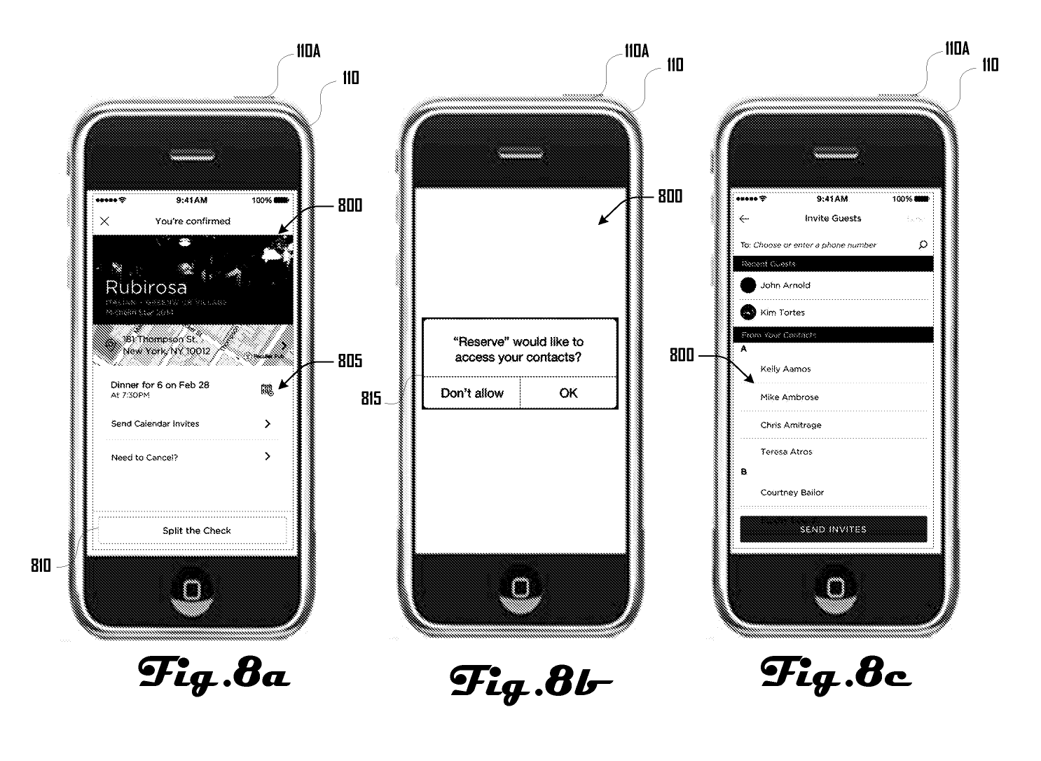

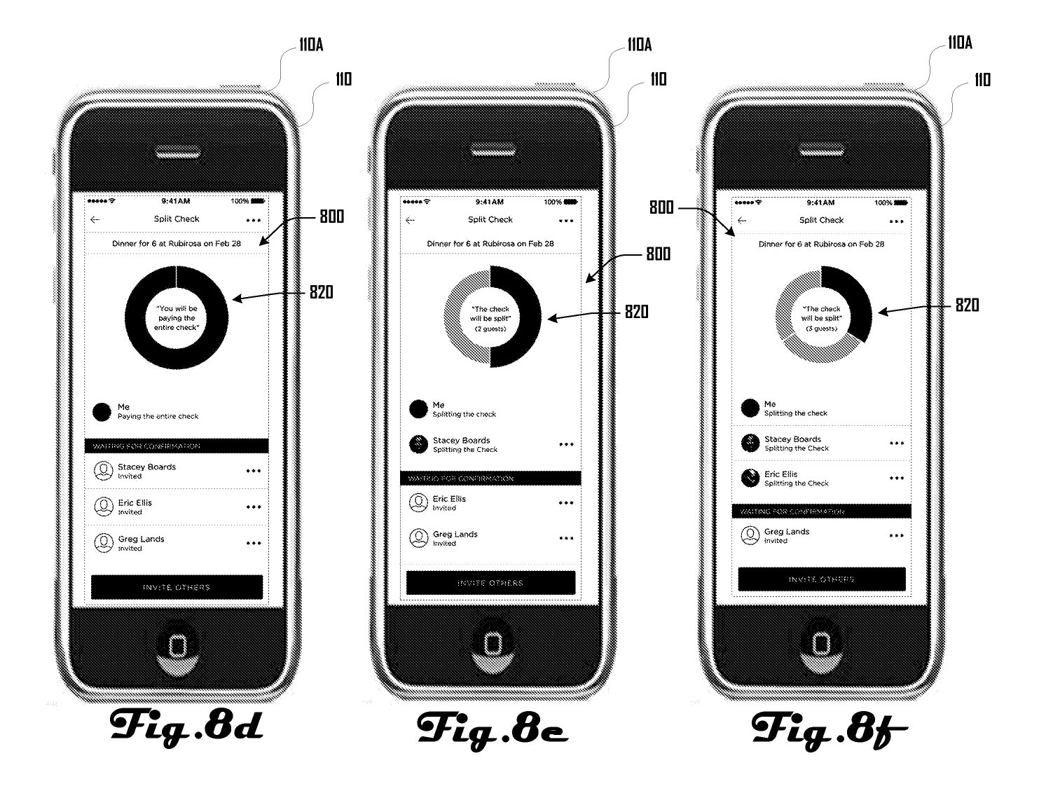

In various embodiments, the system 100 (shown in FIG. 1) can be configured to split a bill among a group of participants. In one example, the bill for a meal at a restaurant can be split among a group of diners that shared the meal. In some embodiments, users participating in or otherwise associated with a reservation are automatically joined in a split set. Additionally and/or alternatively, in further embodiments, users participating in or otherwise associated with a reservation are not automatically added to a split set and can be invited to join a split set. FIG. 6 is an exemplary data flow diagram illustrating an embodiment of communication 600 between user devices 110 and an application server 120 for a splitting a bill wherein users are not automatically added to a split set when joining a reservation. The communication begins where a bill split is initiated, at 605.

Returning to FIG. 6, at 610, one or more joined participants are selected, and, at 615, participant selections are sent to the application server 120, where split requests are sent to the first and second joined user device 110B, 110C, at 620 and 625, respectively.

Returning to FIG. 6, at 630, the split request is accepted at the first joined user device 110B, and a participant split confirmation is sent to the application server 120, at 635, where the first user is associated with the bill split, at 640. A participant split confirmation is sent to the organizing user device 110A, at 645.

Returning to FIG. 6, at 650, the split request is accepted at the second joined user device 110C, and a participant split confirmation is sent to the application server 120, at 655, where the second user is associated with the bill split, at 660. A participant split confirmation is sent to the organizing user device 110A, at 665.

Returning to FIG. 6, at 670, a split bill pay is initiated. In various embodiments, a split bill pay can include initiating a credit card transaction that charges the set of participants that have joined the split. In some embodiments, such a split can be an even proportional split (e.g., with four participants splitting, each would pay 25% of the bill). In further embodiments, the amount being paid by each participant can be any suitable amount, which can be defined by the organizing participant and/or a joining participant. While some embodiments apply to a set of participants that are physically present at an event, in some embodiments, participants need not be physically present at an event to join a reservation and/or participate in bill splitting.

Billing and bill splitting can be achieved in various suitable ways. For example, in some embodiments, an establishment device 130 (shown in FIG. 1) can input a final bill to the application server 120 that is associated with a given reservation, and the participants associated with the given bill can the pay the bill. In further embodiments, a running bill can be maintained throughout an event, and the organizing participant and/or joining participant of a given reservation can choose to finalize the bill and pay the bill. In some embodiments, participants are required to accept a bill before it is paid; however, in other embodiments, bills can be automatically paid based on certain defined events. For example, in some embodiments, a bill can be automatically split and/or paid at a designated time or after a designated time period (e.g., three hours after a reservation begins and/or automatically at closing time of the establishment).

Additionally, payment and/or splitting of a bill can be based on location of a user device 110. For example, when a given user device 110 is determined to have left the establishment, the participating user associated with the user device 110 can be billed automatically. Such a payment method can be desirable so that participants can pay a proportional share of a bill that corresponds only to the time that the user was present at the event. Alternatively, once all participating users associated with a reservation are determined to have left the establishment, the bill can be automatically paid. This alternative can be desirable so that participants at an event can pay a bill without having to interact with staff at an establishment and/or interact with other participants to pay a bill.

Payments can be achieved in various suitable ways. For example, in one embodiment, payments can be processed by the application server 120, which can provide payment to an establishment. In further embodiments, payments can be processed by the establishment device 130 (shown in FIG. 1). Additionally, any suitable payment method can be used, and different users can use different payment methods. For example, payment methods can include a credit card, debit card, gift certificate, e-wallet, PayPal, automated clearing house (ACH) payment, cash, check, or the like.

FIG. 7 is an exemplary flow chart illustrating an embodiment of a method 700 for a splitting a bill. As shown in FIG. 7, the method 700 beings, at 710, where a determination is made whether a split function is available. For example, in some embodiments, where there are no other participants associated with a reservation, a split function may not be available. Additionally, in some embodiments, where an establishment is required to post a final bill before the bill can be paid, the split function may not become available until such a finalized bill is posted. Additionally and/or alternatively, in further embodiments, splitting arrangements can be made at any time, including before a reservation, during a reservation, and/or after a reservation.

A loop begins, at 720, for all joined participants, which begins, at 730, where a determination is made whether a split invitation is received for a given participant. If a split invitation is received for the participant, a join invitation is sent to the selected participant, at 740. At 750, a determination is made whether the participant has accepted the split invitation, and, if so, the participant is added to the split set, at 760. At 770, the loop ends for all joined participants.

At 780, a determination is made whether additional time should be given for further participants to join the split set. For example, if additional participants are being invited to a reservation, if additional joined participants will be invited to join the split set or if outstanding split set invitations exist, it can be desirable to wait for action by such joining users or by an organizing user. However, if waiting is not desired, then, at 790, the bill is split among the participants in the split set.

In various embodiments, the billing system 100 can be configured to provide various other functionalities related to making reservations at an establishment, ordering goods and/or services at an establishment, obtaining customer service at an establishment, and/or paying bills from an establishment.

For example, in some embodiments, a user can view a menu and place an order via a user device 110, and ordering data can be sent to the application server 120 and/or establishment device 130 (shown in FIG. 1). Orders can be input via buttons, a touch screen, or voice. In some embodiments, a user can call a waiter or request other customer service via a user device 110 and service data can be sent to the application server 120 and/or establishment device 130. Service data can be input via buttons, a touch screen, or voice. In various embodiments, the establishment device 130 can provide an alert to a waiter or other staff of a pending customer service request, which can include an alert on a screen, a blinking light, an audio alert, a vibration or the like. In some embodiments, each waiter can have an establishment device 130 and/or there can be a centralized establishment device 130 for all waiters to use.

Accordingly, in various embodiments, a waiter or staff identifier and/or establishment device identifier can be associated with a reservation so that one or more waiter or staff member associated with the reservation can receive alerts, orders, or bill the reservation.

In further embodiments, reservations can be generated based on location of a user device 110. For example, in some embodiments, a user can search for establishments that are within proximity to the user's user device 110. Additionally, when a user device 110 is determined to be proximate to an establishment, then the user can be prompted to make a reservation. Such a proximity determination can be made by the application server 120 and/or an establishment device 130 (shown in FIG. 1). Although reservations at an establishment discussed herein can relate to an event some time hours, days, weeks, months or years in the future, in further embodiments, reservations can be made which correspond to an event at an establishment that has already begun or as a beginning to an event. For example, a user can make a reservation after walking into an establishment or after sitting down at a table in an establishment. In other words, a reservation can serve to open up a tab at an establishment in addition to reserving a location or time slot at an establishment.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method of splitting a bill, comprising:
selecting a first invitee user profile for addition to a split set being associated with a reservation and initially comprising an organizing user profile;
sending a split invitation to a first invitee user device associated with the first invitee user profile;
receiving a split-accept notification from the first invitee user device;
adding the first user profile to the split set; and
paying the bill by:
paying a first portion of the bill via a first payment method associated with the first invitee user profile; and
paying a second portion of the bill via a second payment method associated with the organizing user profile.

2. The method of claim 1, wherein the first invitee user profile and organizing user profile are associated with the reservation before the first invitee profile is added to the split set.

3. The method of claim 1, wherein the reservation is further associated with an establishment.

4. The method of claim 3, wherein the establishment is at least one of a restaurant and a bar.

5. The method of claim 3, wherein the reservation is further associated with a location at the establishment.

6. The method of claim 1, wherein at least one of the first payment method and the second payment method comprises one of a credit card and debit card.

7. The method of claim 1, wherein said paying the bill occurs automatically without user interaction.

8. The method of claim 7, wherein said paying the bill occurs based on at least one of a defined time and length of time from a reservation time associated with the reservation.

9. The method of claim 7, wherein said paying the bill occurs based on the location of at least one of the first invitee user device and an organizing user device associated with the organizing user profile.

10. The method of claim 1, further comprising:
selecting a second invitee user profile for addition to the split set;
sending a split invitation to a second invitee user device associated with the second invitee user profile;
receiving a split-accept notification from the second invitee user device; and
adding the second user profile to the split set,
wherein said paying the bill further comprises paying a third portion of the bill via a third payment method associated with the second invitee user profile.

11. The method of claim 1, further comprising generating the reservation at an organizing user device.

12. The method of claim 11, further comprising selecting a first user profile via the organizing user device for association with the reservation.

13. The method of claim 12, further comprising displaying a plurality of candidates for joining the reservation, the first user profile being one of the plurality of displayed candidates.

14. The method of claim 13, wherein the plurality of candidates for joining the reservation includes at least one organizing user contact stored on the organizing user device.

15. The method of claim 14, wherein said selecting the first user profile at the organizing user device triggers sending a join invitation to a first user device.

16. The method of claim 15, further comprising receiving a join invitation acceptance from the first user device and associating the first user profile with the reservation as the first participating user profile.

17. The method of claim 16, further comprising:
selecting a second user profile at the organizing user device for association with the reservation, wherein said selecting the second user profile at the organizing user device triggers sending a join invitation to a second user device; and
receiving a join invitation acceptance from the second user device and associating the second user profile with the reservation as a second participating user profile.

18. The method of claim 11, further comprising receiving a reservation search query from a first user device and providing a set of reservation search results to the first user device comprising the reservation.

19. The method of claim 18, further comprising:
receiving a reservation selection from the first user device;
sending a participant request to the organizing user device associated with a first user profile associated with the first user device;
receiving a participant join approval from the organizing user device; and
associating the first user profile with the reservation as the first participating user profile.

20. The method of claim 1, further comprising:
receiving a customer service request associated with the reservation from a user device; and
sending a customer service notification to an establishment device associated with the reservation.

21. The method of claim 1, further comprising:
receiving an order associated with the reservation from a user device; and
sending an order notification to an establishment device associated with the reservation.

22. An apparatus for splitting a bill, comprising a computing device configured for:
receiving from an organizing user device a selection of a first invitee user profile for addition to a split set being associated with a reservation and initially comprising an organizing user profile;
sending a split invitation to a first invitee user device associated with the first invitee user profile;
receiving a split-accept notification from the first invitee user device;
adding the first user profile to the split set; and
paying the bill by:
paying a first portion of the bill via a first payment method associated with the first invitee user profile; and
paying a second portion of the bill via a second payment method associated with the organizing user profile.
